(19) United States
(12) Patent Application Publication
(10) Pub. No.: US 2011/0119680 A1
(43) Pub. Date: May 19, 2011

(54) POLICY-DRIVEN SCHEMA AND SYSTEM FOR MANAGING DATA SYSTEM PIPELINES IN MULTI-TENANT MODEL

(75) Inventors: Wei Li, Foster City, CA (US); Kazi Atif-Uz Zaman, Redwood City, CA (US)

(73) Assignee: YAHOO! INC., Sunnyvale, CA (US)

(21) Appl. No.: 12/618,984

(22) Filed: Nov. 16, 2009

(51) Int. Cl. G06F 9/46

(52) U.S. Cl. 718/106

(57) ABSTRACT

Methods and apparatus are described for managing data flows in a high-volume system. Jobs are grouped into pipelines of related tasks. A pipeline controller accepts schemas defining the jobs in a pipeline, their dependencies, and various policies for handling the data flow. Pipelines may be smoothly upgraded with versioning techniques and optional start/stop times for each pipeline. Late data or job dependencies may be handled with a number of strategies. The controller may also mediate resource usage in the system.

### BACKGROUND OF THE INVENTION

The present invention relates to distributed computing, and more specifically to managing large work flows on such systems.

Large portal companies such as Yahoo continuously generate an enormous amount of data, including user data, from web searches to social relationships to geolocation data, and system data such as various performance metrics. Deriving useful information from the large volume of raw data supports a variety of business objectives, including presenting relevant contextual information, identifying trends in user behavior, and offering better targeted services.

Extracting the desired information from the raw data requires significant resources, and is often done in the context of a computing cluster that runs many jobs across its nodes. Each job may locate the raw data of interest and apply business logic to derive the sought-after results. Various jobs are scheduled to run at periodic intervals such as hourly, daily, and weekly according to the data flow and business needs. A business task such as “find the ten most frequent search terms during the past hour” may entail the coordination of hundreds of related jobs.

A hefty infrastructure is needed to support this data flow processing. Software tools such as job schedulers and resource managers can be used to assign and run jobs on nodes in the cluster. However, creating jobs and sets of related jobs still requires much manual intervention. Tasks such as managing dependencies between jobs, handling data which arrives out-of-order, upgrading the jobs related to a given process, and managing system capacity can be tedious and error-prone. The owner of each task typically rolls their own solution to these and related management problems, making the system fragile and changes difficult.

### SUMMARY OF THE INVENTION

According to the present invention, methods, systems, and computer program products are presented for managing a plurality of pipelines. Each pipeline is described by a schema comprising a pipeline identifier, a pipeline version, an active timeframe, a set of jobs, dependencies between the jobs, a resource requirement, and a catchup policy for handling delayed jobs. A pipeline controller receives these schemas and registers them if the resource requirements can be satisfied by system constraints. The controller manages operation of the pipelines with reference to the system constraints and the resource requirements specified by the registered pipeline schemas. This includes scheduling jobs associated with each registered pipeline to run on the cluster during the corresponding active timeframe according to the dependencies between the associated jobs. Delayed jobs are scheduled according to the catchup policy.

A further understanding of the nature and advantages of the present invention may be realized by reference to the remaining portions of the specification and the drawings.

### BRIEF DESCRIPTION OF THE DRAWINGS

FIG. 1 depicts an example environment for practicing certain embodiments of the invention.

FIG. 2 presents an idealized model of pipeline data flow according to embodiments of the invention.

FIG. 3 shows a particular embodiment of a pipeline controller.

FIG. 4 illustrates a particular embodiment of a pipeline with dependencies between various jobs.

FIG. 5 is a flowchart depicting a method for practicing certain embodiments of the invention.

FIG. 6 illustrates a variety of computing contexts in which embodiments of the invention may be employed.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

As internet usage climbs, network service providers must provision more and more resources to support their user base. Increasingly sophisticated online applications and higher user expectations drive demand even higher. Clusters of many machines are needed to provide the processing power and storage space to fill these needs. With growth in cluster size and user base comes an explosion in the amount of data that must be processed. Simply keeping up with the data flow entails complex job management issues.

To support such immense data flows, a pipeline controller is presented. A pipeline is a set of logically grouped jobs related to a data flow. In this context, a job is a series of programs or commands executed by a computing device. Data flow refers to processing a stream of data to extract, amalgamate, or otherwise transform the data into more useful forms. Each pipeline is defined with a schema. The schema declares jobs, their dependencies, and various policies for managing the jobs. With this information, the pipeline controller schedules jobs to run and allows for smooth upgrading. The controller can support multiple schemas representing multiple pipelines, allowing concurrent handling of multiple pipelines by one controller (i.e., multi-tenant execution of pipelines). These features enable pipeline creators to focus on the business logic of their task as a wide variety of pipeline management issues are handled by the pipeline controller. As will become apparent, cluster resources can be more efficiently allocated and system stability improved by these techniques.

Significant changes to a pipeline can be made quickly and simply by editing the schema to declare different policies. For example, changing incoming data formats can be as simple as copying the pipeline schema, incrementing the version number, and specifying the time that the format switch will occur. As another example, a change from discarding stale data to processing it after the most recent data can be effected by simply updating a catchup policy field in the schema. Under prior approaches, such changes would require numerous manual configuration updates. At worst, they could require rewriting large chunks of data processing programs, since prior tools leave policies like handling delayed data up to the job itself.

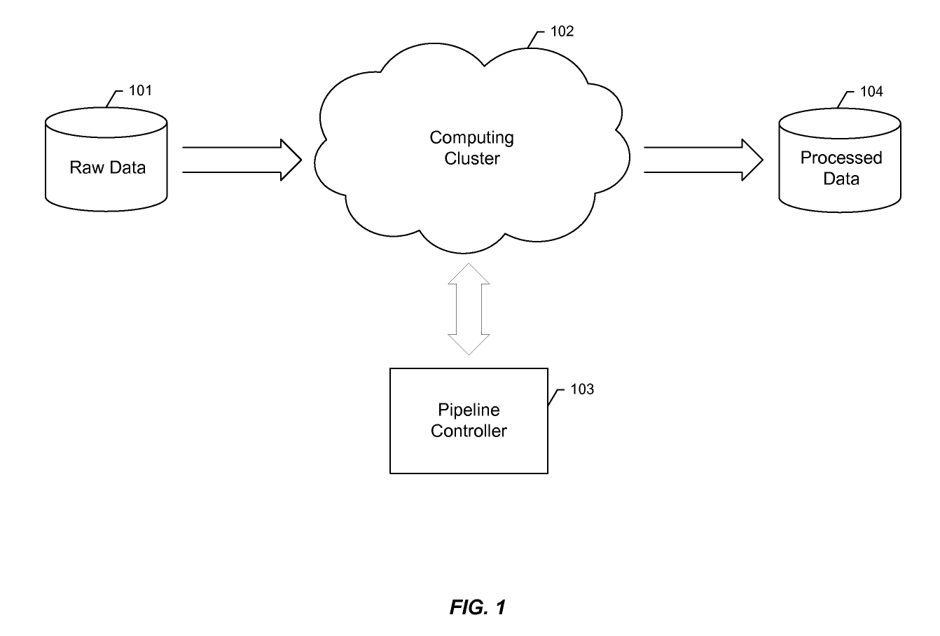

FIG. 1 depicts a simplified representation of an environment for practicing certain embodiments of the invention. The data flow from raw data 101 to cluster 102 to processed data 104 indicates a logical flow. Data store 101 contains raw data gathered by a service provider. The data may comprise user data such as web search terms, advertising click-throughs, or geolocation information. It may also comprise system data such as web server response times, network utilization, or system loads relating to servers monitored by the provider. It will be understood that data store 101 and data store 104 may comprise any suitable storage technology, including any of a wide variety of databases or storage area networks.

Computing cluster 102 contains nodes which run jobs to process the raw data, where a node simply means one or more computing device in the cluster. The jobs are controlled by pipeline controller 103. The pipeline controller is a logical entity which may be implemented on any number of computing devices, including a single server, multiple servers, a distributed computing grid, or any other available hardware. The pipeline controller performs tasks such as managing dependencies between jobs in a pipeline, scheduling jobs to run in a timely manner, assigning each job to one or more nodes on which to execute, and reserving cluster resources to accommodate active pipelines. After a job has run, the results are stored in data store 104.

Some or all of the nodes in cluster 102 may have generated the raw data 101 if the cluster is multipurpose. Alternatively, the data may come from a separate source, such as a remote data center. Similarly, data stores 101 and 104 may share storage space or exist independently.

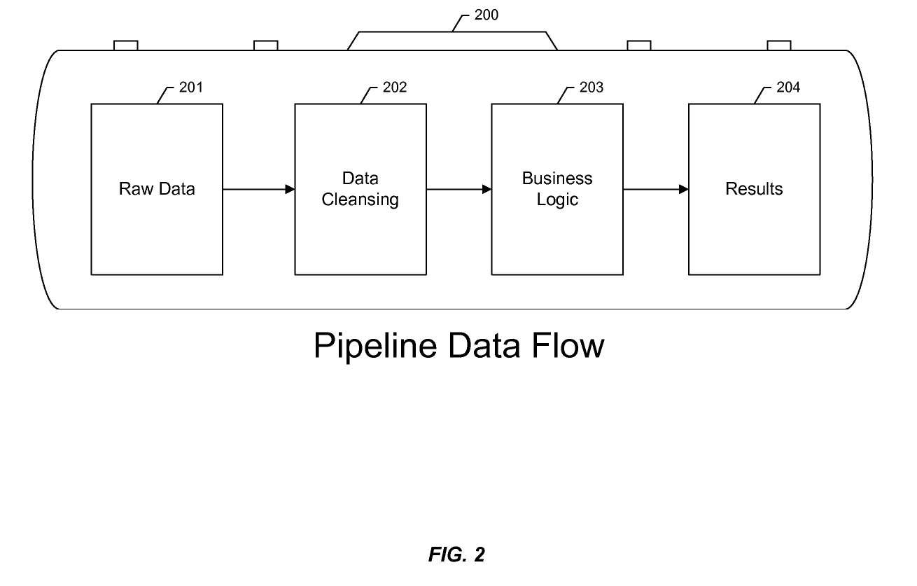

FIG. 2 presents an idealized model of pipeline data flow according to embodiments of the invention. Pipeline 200 processes raw data 201. The data is cleansed 202 by one or more jobs on the cluster. Cleansing may entail operations such as normalizing data points, discarding bad data, or removing extraneous information. Business logic 203 includes jobs which analyze the cleansed data for desired information. For example, the business logic for a web trends pipeline may count the frequency for every search term entered in the last hour and return the top ten. The pipeline ends when all jobs have run and results 204 are produced. The results may then be used as input to other programs, such as a program which presents a graphical display of web server performance.

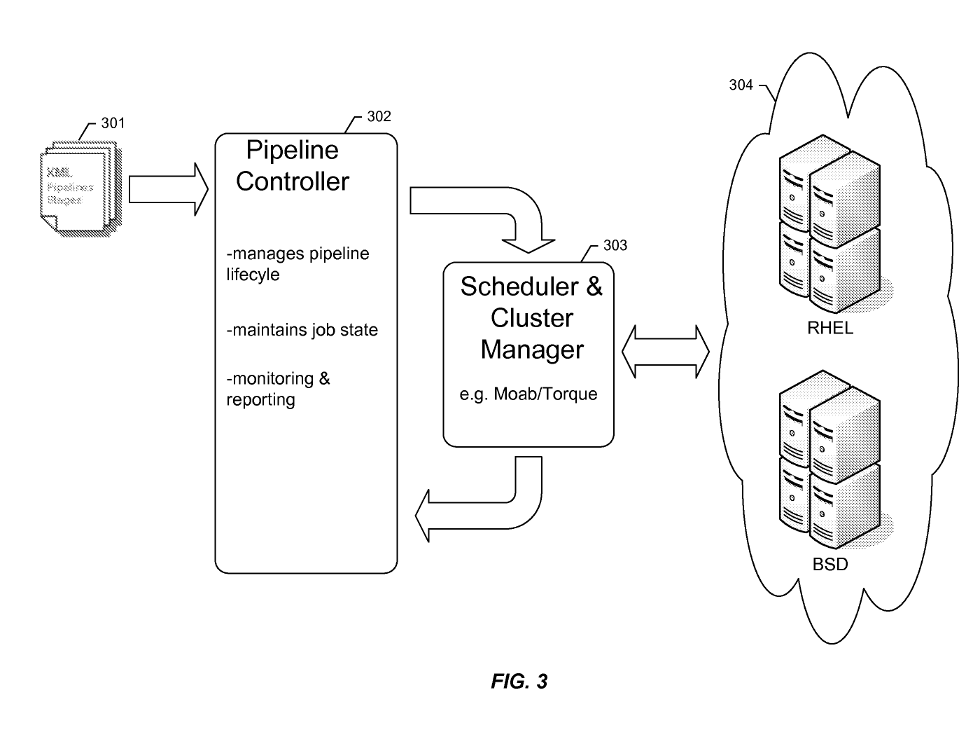

FIG. 3 shows a particular embodiment of a pipeline controller. The pipeline controller 302 accepts schemas 301 declaring pipelines of jobs. While schemas are declared with XML (Extensible Markup Language) in this example, embodiments of the invention may accept schemas in any of a wide variety of suitable formats as appreciated by those skilled in the art. Each schema declares various attributes and policies of a corresponding pipeline. For example, the schema may declare a pipeline identifier, a set of jobs, dependencies between the jobs, and policies for managing the jobs such as start or end times and deadlines. The pipeline controller translates this information according to the policies into a set of actual jobs for a cluster manager 303 to run. The cluster manager includes a scheduler and a resource manager. The scheduler assigns jobs to run on cluster 304 when sufficient cluster resources are available. The resource manager monitors cluster resources with the help of agent software which runs on each node. When it receives a job from the scheduler, the resource manager selects available nodes in the cluster and launches job execution on those nodes. In some embodiments, existing tools such as may be utilized as the scheduler or resource manager. For example, the Moab Cluster Suite produced by Adaptive Computing Enterprises or its precursor, the open source Maui Cluster Scheduler from the same company, may be used to schedule jobs. Similarly, the Terascale Open-Source Resource and Queue (Torque) Resource Manager derived from NASA's Portable Batch System may be used to manage cluster resources, possibly with a Torque agent running on each node. Feedback on job status is returned to a monitoring component of pipeline controller 302 by the cluster manager.

Further operation of the pipeline controller can be understood with reference to a sample pipeline schema according to an embodiment of the invention. This schema defines selected attributes and policy settings for pipelines. An example of a Document Type Definition (DTD) for this schema is as follows:

```
<?xml version=“1.0” encoding=“UTF-8”?>
<!ELEMENT pipeline
(start_timestamp,end_timestamp?,max_backlog,catchup_policy>
<!ATTLIST pipeline
  name CDATA #REQUIRED
  version CDATA #REQUIRED>
<!ELEMENT start_timestamp (#PCDATA)>
<!ELEMENT end_timestamp (#PCDATA)>
<!ELEMENT max_backlog EMPTY>
<!ATTLIST max_backlog
  cap CDATA #REQUIRED
  shared (True|False) ‘True’>
<!ELEMENT catchup_policy EMPTY>
<!ATTLIST catchup_policy
  value (earliest_first|current_first|ignore) ‘earliest_first’>
<!ELEMENT job (name, dependencies?, . . . )>
```

Each item will be discussed in turn.

The DTD declares two required attributes for the pipeline element. The name attribute provides a unique string to identify the pipeline. The version attribute keeps track of the iterations made to the pipeline over time. For example, the initial version of a recent search term pipeline may be declared as <pipeline name=“webtrends” version=“1.0”>. At a later time, the service provider may incorporate a new job into this pipeline. For instance, in addition to finding the top ten most frequent search terms, the service provider may decide to also find a category each term is most closely associated with. A job locating the category data may be added to the pipeline, and the pipeline version number incremented to 1.1.

The start timestamp and end timestamp elements define the period of time when the pipeline is active, i.e., schedules jobs. For instance, a start time of 20090601 and end time of 20090630 schedules jobs in the pipeline only during June of 2009. How often each job in the pipeline runs is determined separately. For instance, the web trends pipeline may specify some jobs that run hourly and others that run daily when the pipeline is active. When the end timestamp is reached, new jobs in the pipeline are no longer scheduled. However, jobs which are already executing are allowed to complete their runs. Similarly, jobs which were scheduled to run during the active period but were delayed due to data or program dependencies are executed as normal. Thus in a typical pipeline, activity in the pipeline gradually diminishes after the end timestamp passes until all jobs scheduled for the active period have completed.

Some embodiments use these timestamps to manage pipeline upgrades. For instance, suppose the format of raw search term data will change at 3:00 am on 1-1-2010. Programs that handle the search term data may need to be updated, such as a program freqcnt1 that counts the frequency of search terms. However, the old program can not simply be replaced with an updated one—call it freqcnt2—at the time of the switchover. Both freqcnt1 and freqcnt2 will be needed for some period of time as jobs processing the old format are delayed past the cutoff. Instead, a new version of the pipeline is created. For instance, a first pipeline “web trends” declares jobs using the program freqcnt1 with an end_timestamp set for 3:00 am on 1-1-2010. A second pipeline “web trends” declares jobs using program freqcnt2 with a start_timestamp of 3:00 am on 1-1-2010. The first pipeline may be declared as <pipeline name=“webtrends” version=“1.0”>, while the second may be declared as <pipeline name=“webtrends” version=“1.1”>. This ensures that jobs processing the old data run the correct freqcnt1 program, even if the data arrives late or the jobs are delayed past the switchover to the new data format.

According to some embodiments, upgrade dates, or even whether a pipeline will ever be upgraded, need not be known ahead of time. The end_timestamp may be left blank when the pipeline is first created. Later, when an upgrade time becomes known, the end_timestamp may be modified dynamically in an already-running pipeline.

The max_backlog element may be used to manage capacity of the cluster. The pipeline controller sets limits on the number of cluster resources that can be allocated to the sum total of pipelines in the system. The limits may be expressed in terms of various types of resources, such as processor time, bandwidth utilization, or storage space. These limits may be treated as hard or soft according to various embodiments. Each pipeline schema then declares the number of resources that the pipeline may require at any one time. If the pipeline controller has enough available resources to meet the demand, it accepts the pipeline.

In one example, the pipeline controller sets a hard limit on the total number of concurrently executing jobs that the cluster will handle. This overall limit may be determined in a variety of ways, such as being derived automatically from cluster metrics or based on estimations by cluster operators. The limit may be set lower than maximum cluster capacity to allow for other cluster uses. Each pipeline then declares its own job usage. For instance, a schema setting of <max_backlog cap=“5000”>declares that the pipeline may run up to 5000 jobs at one time. If the controller has 5000 or more jobs available after subtracting the usage of already accepted pipelines from the overall limit, the new pipeline will be accepted. In some embodiments, the pipeline may run many fewer jobs than the declared limit under normal circumstances. The pipeline limit may account for situations where jobs are delayed or data arrives late, requiring extra processing than normal to catch up on results.

The max_backlog element also defines a shared attribute which may be used when upgrading a pipeline. When the shared attribute is True, the pipeline capacity is split between multiple versions of the same pipeline. Continuing an earlier example, suppose the older version of the web trends pipeline declares <max_backlog cap=“4000” shared=“True”> while the newer version declares <max_backlog cap=“5000” shared=“True”>. The newer version requires 5000 resources (in this case, concurrent jobs), which is 1000 more than the older version. Without the shared attribute, the two pipelines would together require 9,000 resources from the controller. However, when shared is on, the two pipelines will share the requested resources between them. In this case, only 5,000 resources are needed to satisfy both pipelines. Since the second pipeline is a newer version, the first pipeline will presumably be winding down operations (running delayed jobs, handling late data) as the second is ramping up. Thus it is unlikely that both pipelines will simultaneously require their maximum requested resources.

The catchup_policy element declares a strategy for handling delayed jobs. Jobs may be delayed by data which arrives late or out of order. Delay may also occur due to dependencies on other jobs which do not finish their processing on time. The example schema defines three sample catchup policies. The earliest_first policy indicates that all jobs should be run sequentially in the order scheduled. If data arrives late, the oldest data is processed first. For instance, suppose data covering a three-hour time span arrives all at once. An earliest_first policy on a pipeline with an hourly job would first run jobs on the three-hour old data, then the two-hour old data, and so on until processing catches up to the current time. This policy would be useful for applications like a pipeline that measures the click rate on various advertisements. If advertisers are charged for every click on their ad, then all the data must be processed to calculate the correct amount to charge.

By contrast, a current_first policy indicates that the most current data should be processed first, with other data backfilled later. This is useful where having up-to-date data is more important. For example, an application monitoring system performance may be primarily interested in the current system state to ensure problems are detected and fixed in a timely manner. Older data may be useful for historical insights such as planning upgrades, but may be filled in later since it is not as critical.

An ignore policy tells the pipeline controller to toss out old data and jobs, only running the most current ones. This is useful where historical data serve little purpose. For instance, a web trends pipeline may only wish to show the most recent list of frequent search terms. Since older data would be of no use, the pipeline may choose it ignore it in favor of newer data.

In one class of embodiments, jobs are defined using a <job> element. This element may allow a number of attributes depending on the embodiment. The name attribute allows jobs to be identified so that dependencies on other jobs may be specified with the dependencies attribute. The job name also aids in logging the progress and results of jobs based on feedback to the monitoring component. Other attributes may optionally appear in certain embodiments, as denoted by the ellipsis in the job element definition. A schedule attribute defines what times or events trigger the job to run, such as hourly or when a certain piece of data arrives. Parameters to the job may be provided through the config attribute. A catchup attribute allows jobs to define their own catchup policy separate from the general pipeline one. With a callback attribute, the job can specify a command to run when the job finishes. For instance, this may be used to notify an administrator after an important daily report has been generated. Programs or commands may be specified inside the job element, such as:

<job name=“frequency count” schedule=“hourly”>freqcnt1</job>
In some embodiments, additional attributes may be defined and passed to the scheduler or resource manager to expedite their handling of the job.

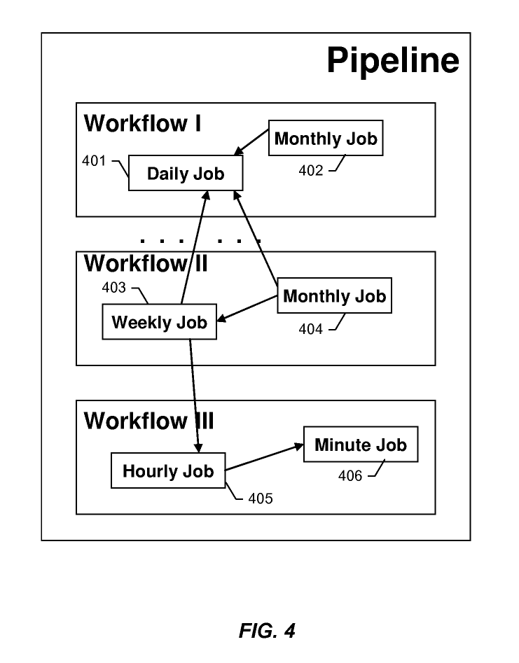

FIG. 4 illustrates a particular embodiment of a pipeline with dependencies between various jobs. Jobs 401-406 are scheduled at various intervals indicated by their respective names. That is, job 406 is scheduled to run once a minute, job 405 is scheduled for once an hour, job 401 is scheduled for every day, job 403 is scheduled for once a week, and jobs 402 and 404 are scheduled for once a month. The jobs are further grouped into three workflows indicating a logical organization among the jobs. For example, the pipeline may define jobs related to performance monitoring, with workflow I producing a daily report, workflow II producing historical averages, and workflow III measuring the current system state. The arrows indicate dependencies between the jobs. For instance, monthly job 404 depends on both weekly job 403 and daily job 401. As an example, suppose monthly job 404 was scheduled to run on June 1, producing a report on historical averages for the prior month. Before job 404 may run, daily job 401 must be run for every day in May, and weekly job 403 must be run for every week in May. Once these dependencies have completed their executions, the pipeline controller will schedule job 404 to run.

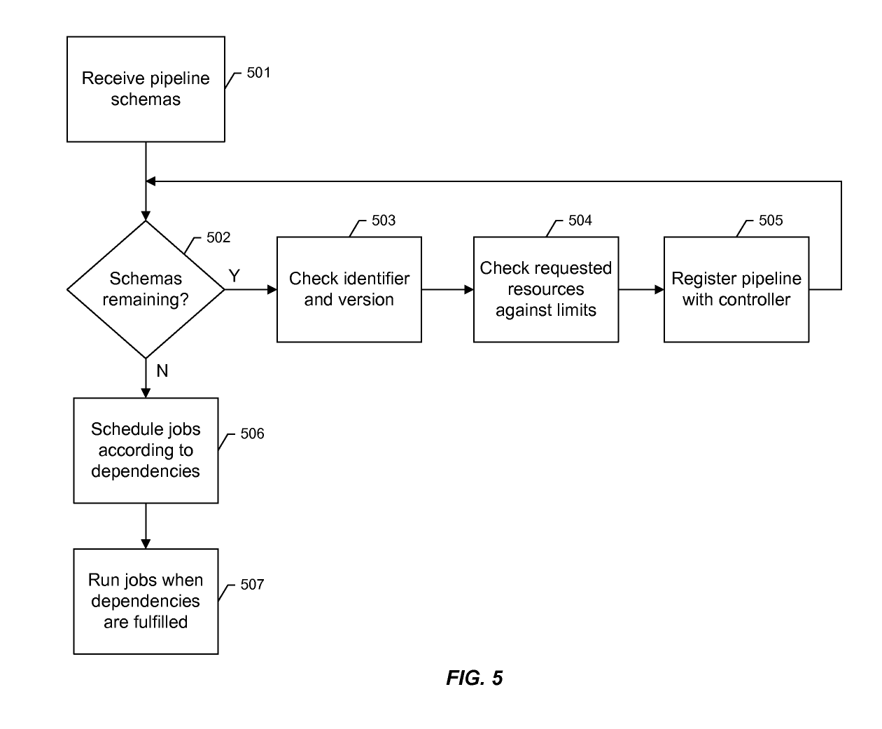

FIG. 5 is a flowchart depicting a method for practicing certain embodiments of the invention. The pipeline controller receives a group of schemas defining pipelines for the system (501). Each schema is processed in turn. While there are schemas remaining to be processed (502), one of the schemas is selected. The identifier and version declared in the schema is checked (503) to make sure the controller isn't already running this pipeline. The resource allocations declared in the schema are checked against the controller's resource limits (504). For example, an administrator may decide to allocate 70% of a cluster's computation time to data flow pipelines, keeping 30% for other uses. This might be expressed as a controller limit on processor time, with each pipeline schema declaring the peak amount of processor time its jobs require. If the controller has sufficient resources to accommodate the pipeline, the pipeline is accepted (505). This process continues until all schemas have been processed and either accepted or rejected by the controller. Further schemas may be submitted to the pipeline at any point in time, triggering this process again. Once the controller has accepted one or more pipelines, it schedules the jobs declared in them (506). Each job may define one or more dependencies which must be fulfilled before they run. Data dependencies may be handled in several ways. Jobs may run long enough after scheduled data arrival to ensure the data is present. For instance, each run of an hourly job may process data from six hours before to give late data a chance to arrive. Alternately, the data gathering system may signal the controller when a complete chunk of data arrives, with a job scheduled to begin after receiving the signal. Jobs may also begin at a scheduled time and block until their data becomes unavailable. Late data may also be reprocessed as it comes in. For instance, a pipeline may declare one job to generate initial results from data which arrives on-time and a clean-up job which runs at a later time to update the results with any data which arrived late. Many other data dependency strategies will be familiar to those skilled in the art. Once a job's data and processing dependencies are fulfilled, it may execute on the cluster (507).

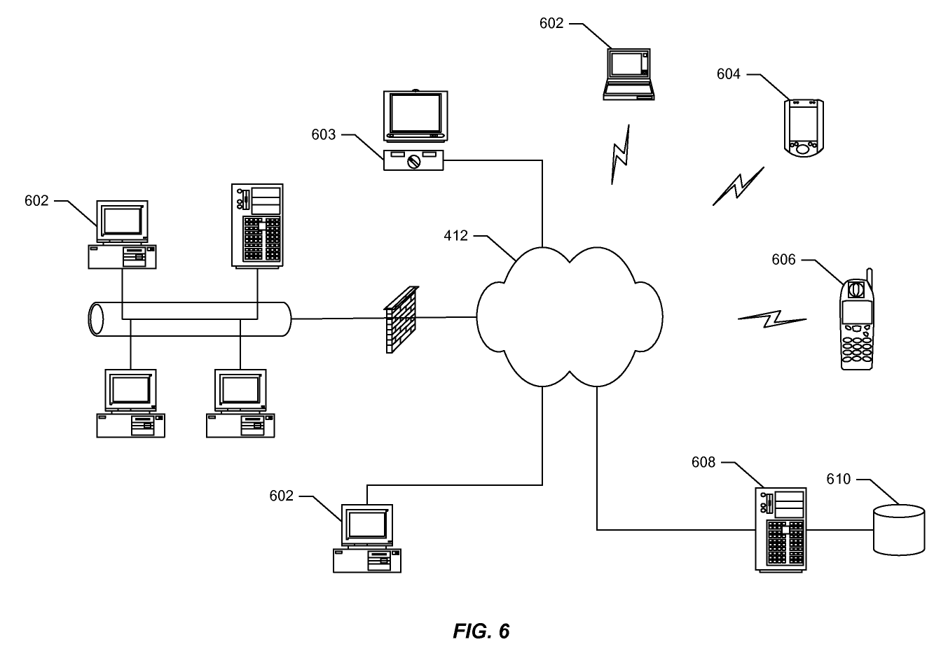

Embodiments of the present invention may be employed to identify and exploit data gathered in any of a wide variety of computing contexts. For example, as illustrated in FIG. 6, implementations are contemplated in which the relevant population of users (e.g., Yahoo! users) interact with a diverse network environment via any type of computer (e.g., desktop, laptop, tablet, etc.) 602, media computing platforms 603 (e.g., cable and satellite set top boxes and digital video recorders), handheld computing devices (e.g., PDAs) 604, cell phones 606, or any other type of computing or communication platform.

And according to various embodiments, user data processed in accordance with the invention may be collected using a wide variety of techniques. For example, collection of data representing a user's interaction with a web site or web-based application or service (e.g., the number of page views) may be accomplished using any of a variety of well known mechanisms for recording a user's online behavior. User data may be mined directly or indirectly, or inferred from data sets associated with any network or communication system on the Internet. In addition, data relating to the performance and availability of resources in the network may be generated and gathered according to a wide variety of conventional and proprietary techniques. And notwithstanding these examples, it should be understood that such methods of data collection are merely exemplary and that user data may be collected in many ways.

Once collected, the data may be processed in accordance with embodiments of the invention in some centralized manner. This is represented in FIG. 4 by server 608 and data store 610 which, as will be understood, may correspond to multiple distributed devices and data stores. The invention may also be practiced in a wide variety of network environments including, for example, TCP/IP-based networks, telecommunications networks, wireless networks, etc. These networks, as well as the various communication systems from which data may be aggregated according to the invention are represented by network 412.

Although described in terms of processing data flows, the invention is not limited to these embodiments. Rather, the invention may be practiced to manage any type of job execution in a distributed environment. For example, some embodiments may manage jobs that are not based on high-volume data flow, such as processor-bound jobs which require large amounts of processing time and relatively little data. Examples of processor-bound jobs include jobs such as protein folding computations, chess-playing programs, and astronomical simulations. Similarly, the cluster need not comprise machines in one physical location; any network of connected machines will suffice. The invention is also not limited to checking pipeline constraints expressed as system resources. Various embodiments may use any constraint which can be programmatically expressed and enforced. For instance, a system constraint may only allow a certain number of pipelines to run on Saturdays. As another example, a pipeline manager may offer pipelines different classes of service, with higher-priority pipelines allocated more time or resources than lower-priority pipelines.

In addition, the computer program instructions with which embodiments of the invention are implemented may be stored in any type of computer-readable storage media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for managing a plurality of pipelines comprising:
receiving a plurality of pipeline schemas, each schema comprising a pipeline identifier, a pipeline version, an active timeframe, a set of jobs, dependencies between the jobs, a resource requirement, and a catchup policy for handling delayed jobs;
registering each pipeline schema with a pipeline controller if system constraints will accommodate the resource requirement associated with the corresponding schema;
managing operation of the plurality of pipelines corresponding to the registered pipeline schemas in a cluster of computing devices with reference to the system constraints and the resource requirements specified by the registered pipeline schemas, managing operation of the pipelines including scheduling jobs in the set of jobs associated with each registered pipeline schema to run on the cluster during the corresponding active timeframe according to the dependencies between the associated jobs, wherein delayed ones of the associated jobs are scheduled according to the catchup policy.

2. The method of claim 1, wherein the catchup policy consists of one of (i) processing delayed jobs in an originally scheduled order, (ii) processing more recent jobs ahead of older jobs, (iii) canceling older jobs in favor of corresponding ones of the more recent jobs, or (iv) processing jobs according to service levels associated with the corresponding pipelines.

3. The method of claim 1, wherein the system constraints comprise one or more of (i) a number of available computing devices in the cluster, (ii) a number of processes to execute in the cluster, (iii) available processor resources in the cluster, or (iv) available input or output bandwidth in the cluster.

4. The method of claim 1 wherein the active timeframe comprises a first timestamp indicating a start time and a second timestamp indicating an end time for scheduling jobs in the pipeline, the method further comprising specifying the second timestamp for a particular one of the pipelines after registering the corresponding pipeline schema and during operation of the particular pipeline.

5. The method of claim 1 further comprising upgrading a first version of a particular pipeline defined in a first schema with a second version of the particular pipeline defined in a second schema, the method further comprising terminating scheduling jobs associated with the first version of the particular pipeline and beginning scheduling jobs associated with the second version of the particular pipeline according to an upgrade time provided by the second schema.

6. The method of claim 1 wherein managing operation of the pipelines further comprises sharing a resource requirement between a first version of a particular pipeline and a second version of the particular pipeline in the plurality of pipelines.

7. The method of claim 1 further comprising scheduling one or more jobs in the plurality of pipelines to run a second time after data delayed past a first scheduled run time of the one or more jobs arrives.

8. A system for managing a plurality of pipelines comprising one or more computing devices configured to:
receive a plurality of pipeline schemas, each schema comprising a pipeline identifier, a pipeline version, an active timeframe, a set of jobs, dependencies between the jobs, a resource requirement, and a catchup policy for handling delayed jobs;
register each pipeline schema with a pipeline controller if system constraints will accommodate the resource requirement associated with the corresponding schema;
manage operation of the plurality of pipelines corresponding to the registered pipeline schemas in a cluster of computing devices with reference to the system constraints and the resource requirements specified by the registered pipeline schemas, managing operation of the pipelines including scheduling jobs in the set of jobs associated with each registered pipeline schema to run on the cluster during the corresponding active timeframe according to the dependencies between the associated jobs, wherein delayed ones of the associated jobs are scheduled according to the catchup policy.

9. The system of claim 8, wherein the catchup policy consists of one of (i) processing delayed jobs in an originally scheduled order, (ii) processing more recent jobs ahead of older jobs, or (iii) canceling older jobs in favor of corresponding ones of the more recent jobs.

10. The system of claim 8, wherein the system constraints comprise one or more of (i) a number of available computing devices in the cluster, (ii) a number of processes to execute in the cluster, (iii) available processor resources in the cluster, or (iv) available input or output bandwidth in the cluster.

11. The system of claim 8 wherein the active timeframe comprises a first timestamp indicating a start time and a second timestamp indicating an end time for scheduling jobs in the pipeline, the system further configured to allow specifying the second timestamp for a particular one of the pipelines after registering the corresponding pipeline schema and during operation of the particular pipeline.

12. The system of claim 8 further configured to upgrade a first version of a particular pipeline defined in a first schema with a second version of the particular pipeline defined in a second schema, the system further configured to terminate scheduling jobs associated with the first version of the particular pipeline and begin scheduling jobs associated with the second version of the particular pipeline according to an upgrade time provided by the second schema.

13. The system of claim 8 further configured to manage operation of the pipelines by sharing a resource requirement between a first version of a particular pipeline and a second version of the particular pipeline in the plurality of pipelines.

14. The system of claim 8 further configured to schedule one or more jobs in the plurality of pipelines to run a second time after data delayed past a first scheduled run time of the one or more jobs arrives.

15. A computer program product for managing a plurality of pipelines comprising at least one computer-readable storage medium having computer instructions stored therein which are configured to cause one or more computing devices to:
receive a plurality of pipeline schemas, each schema comprising a pipeline identifier, a pipeline version, an active timeframe, a set of jobs, dependencies between the jobs, a resource requirement, and a catchup policy for handling delayed jobs;
register each pipeline schema with a pipeline controller if system constraints will accommodate the resource requirement associated with the corresponding schema;
manage operation of the plurality of pipelines corresponding to the registered pipeline schemas in a cluster of computing devices with reference to the system constraints and the resource requirements specified by the registered pipeline schemas, managing operation of the pipelines including scheduling jobs in the set of jobs associated with each registered pipeline schema to run on the cluster during the corresponding active timeframe according to the dependencies between the associated jobs, wherein delayed ones of the associated jobs are scheduled according to the catchup policy.

16. The computer program product of claim 15, wherein the catchup policy consists of one of (i) processing delayed jobs in an originally scheduled order, (ii) processing more recent jobs ahead of older jobs, or (iii) canceling older jobs in favor of corresponding ones of the more recent jobs.

17. The computer program product of claim 15, wherein the system constraints comprises one or more of (i) a number of available computing devices in the cluster, (ii) a number of processes to execute in the cluster, (iii) available processor resources in the cluster, or (iv) available input or output bandwidth in the cluster.

18. The computer program product of claim 15 wherein the computer instructions are further configured to manage operation of the pipelines by sharing a resource requirement between a first version of a particular pipeline and a second version of the particular pipeline in the plurality of pipelines.

19. The computer program product of claim 15 wherein the computer instructions are further configured to schedule one or more jobs in the plurality of pipelines to run a second time after data delayed past a first scheduled run time of the one or more jobs arrives.
